(19) United States
(12) Patent Application Publication
(10) Pub. No.: US 2010/0305982 A1
(43) Pub. Date: Dec. 2, 2010

(54) SYSTEM AND METHOD FOR DISPLAYING, SELECTING AND PURCHASING SERVICES

(76) Inventors: David Hulse, Athens (GR); David Nicol, Edinburgh (GB)

Correspondence Address: JENKINS, WILSON, TAYLOR & HUNT, P. A., 3100 Tower Blvd., Suite 1200, DURHAM, NC, 27707, US

(21) Appl. No.: 12/601,675

(22) PCT Filed: May 26, 2008
(86) PCT No.: PCT/GB08/50378

§ 371 Date: Jun. 11, 2010

(30) Foreign Application Priority Data
May 24, 2007 (GB) 0710014.2

(51) Int. Cl. G06Q 30/00; G06Q 10/00; H04N 7/18; G06F 7/04; G06F 3/048; G06F 17/30

(52) U.S. Cl. 705/5; 705/16; 725/85; 340/5.81; 715/764; 707/802; 707/769; 707/E17.005; 707/E17.014

(57) ABSTRACT

The system comprises a user interface (3) and middleware (5) which, in turn, comprises control software (7), a database (9) and application programming interfaces (API) (6 and 11a 11d). The middleware (5) is connected to an electronic point of sale device or system (EPOS) (13) as well as sub-systems (15,17,19) such as dedicated booking systems which allow hotel guests to book, for example, the spa (15), the restaurant (17) and the golf course (19). The information provided to the middleware (5) from the sub-systems can be either static information or dynamic information. The system and method allow a hotel guest to access a range of goods and services available in the hotel through a single user interface (3), typically the graphical user interface (GUI) provided on a television or other visual display unit (VDU) that is available to the hotel guest in their room.

### FIELD OF THE INVENTION

The present invention relates to a system and method for displaying, selecting and purchasing goods and/or services in for example, a hotel, lodging, hospital, campus, resort or other similar establishment.

### BACKGROUND TO THE INVENTION

Establishments such as hotels, guest houses, lodgings, motels and the like come in a variety of different forms and sizes. Hotels range from extremely large luxury hotels, resort hotels, hotels predominantly used by business people and budget tourist hotels. In addition, many hotels or lodgings offer self catering facilities such as chalets or lodges in the hotel grounds. Motels also provide similar services. Other establishments such as hospitals and student campuses also provide overnight accommodation.

As well as the core service, namely, the provision of accommodation, establishments are interested in selling additional goods and services to their customers because those sales provide additional income and increase profitability. Examples of extra goods and services are hotel merchandise and hotel facilities such as a spa or sports facilities. Currently, extra services are provided through stand alone systems that exist independently of one another and typically require the guest to seek out the shop or hotel facilities in order to purchase goods and service. Shops or hotel facilities will often be equipped with multiple Electronic Point of Sale (EPOS) systems to take payment from the guest for the goods or services in question. Such systems deal with transactions for the sale of goods and services at a specific outlet and are independent of one another.

For many years establishments have provided in-room entertainment systems consisting of a television which is provided with additional functionality to allow a user to watch the free-to-air television channels, some satellite and subscription channels as well as providing access to a variety of radio stations. These systems also include several pay-per-view television channels which allow the guest to pay to watch a film in their room. In most cases the tariff for watching the film will be added onto the bill via the hotel property management system (PMS). Other services available include internet access and access to services such as alarm calls and check out facilities through the television in the room.

Systems of this type may include a host computer which is connected to one or more sub-systems which provide entertainment services to a guest room. The host computer manages requests from the guest room and sends commands to the different sub-systems which in turn provide the services to the guest room. In general, sub-systems exist for different types of entertainment such as pay-per-view films or video games.

When a guest orders a pay-per-view film, the host computer records the order and gives the command to the video or digital media server to provide the movie to that particular guest room. Similarly, if a guest wishes to play a video game the host computer receives a request, records it and coordinates with a video game engine which provides the video game to the guest room. In addition, the host computer typically coordinates with a property management system such that, when a host computer records a service request it also communicates the information to the property management system which, in turn, adds the charge for the service to the bill for the room.

Establishments such as hotels currently have no easy way of offering a range of goods and services to users that presents the goods and services to the user in a manner that is more convenient for the user and provides an easy mechanism for accepting payment.

### SUMMARY OF THE INVENTION

It is an object of the present invention to provide a system and method that will extend and enhance the type of services that may be available to a guest in his room through the television provided in the room or through another user interface.

In accordance with the first aspect of the invention there is provided a system for displaying, selecting and purchasing goods and/or services in a hotel or lodging, the system comprising:

a user interface adapted to display a range of goods and/or services available for purchase;

at least one sub-system which acts as a source of information on the goods and/or services available for purchase;

a server comprising middleware, the server being in communication with the at least one sub-system to receive the information on the goods and/or services available for purchase and to provide said information to the user interface;

means for gathering and processing information on goods and/or services selected for purchase; and

an electronic point of sale (EPOS) system adapted to receive the information on the good and/or services selected for purchase from the middleware and to process the sale.

The present invention allows the integration or convergence of systems providing a variety of different services to allow the selection and/or purchase of services through a user interface.

Preferably, the EPOS system manages fulfilment of the order for the goods and/or services.

Preferably, the user interface comprises a graphical user interface (GUI) controlled by an input/output device.

Preferably, the GUI comprises a series of templates displayable on a screen, the templates being populated with information from the middleware.

Preferably, the input/output device comprises a set-top box.

Optionally, the input/output device comprises a personal computer, PDA, mobile device or information and sales kiosk.

Optionally the kiosk comprises user identification means.

Optionally, the user identification means comprises a machine readable device.

Optionally, the machine readable device comprises an RFID device.

Preferably, the sub-system comprises a facility or service booking system which can be configured to allow the user to book the services of a spa in the hotel or sports facilities or a time for playing golf, room services or any other similar hotel service.

Preferably, the middleware comprises a database, an application programming interface (API) and a control module.

Preferably, the middleware creates a definition of static information based upon the goods and/or services available for purchase and selectively updates the static information into the database from the subsystem.

Static information may be that which is substantially constant during the time during which the system is in use by a guest, for example, price information, location of a particular service, details of the types of service available.

Preferably, static information is up-dated regularly.

Preferably, static information is up-loaded into the user interface from the database via the middleware when the user interface is started.

Preferably, the definition of static information may be changed to include or exclude certain information depending upon subsystem requirements.

Preferably, the middleware uploads information from the sub-systems to the database.

Preferably, the middleware has a separate interaction with each sub-system.

Optionally, EPOS subsystems are provided by a single server.

Preferably, the middleware creates a definition of dynamic information based upon the goods and/or services available for purchase.

Preferably, the definition of dynamic information may be changed to include or exclude certain information depending upon subsystem requirements.

Preferably, dynamic information may be queried in real time.

Dynamic information may be that which needs regularly updated such as, the availability of certain services, for example tables in a restaurant, times for playing golf or the like.

Preferably, the middleware is adapted to provide dynamic queries of the sub-systems to ascertain the availability or validity of a choice made by a user.

In accordance with a second aspect of the invention there is provided a method for displaying, selecting and purchasing goods or services in a hotel or lodging, the method comprising the steps of:

providing information on the goods and/or services available for purchase from at least one sub-system to middleware in communication with the, at least, one sub-system;

displaying the range of goods and/or services available for purchase on a user interface;

gathering and processing information on goods and/or services selected for purchase; and

sending the information on the good and/or services selected for purchase to an electronic point of sale (EPOS) system and processing the sale.

Preferably, the EPOS system manages fulfilment of the order for the goods and/or services.

Preferably, the user interface comprises a graphical user interface (GUI) controlled by an input/output device.

Preferably, the GUI comprises a series of templates displayable on a screen, the templates being populated with information from the middleware.

Preferably, the sub-system comprises a facility or service booking system which can be configured to allow the user to book the services of a spa in the hotel or sports facilities or a time for playing golf, room services or any other similar hotel service.

Preferably, the middleware comprises a database, an application programming interface (API) and a control module.

Preferably, the middleware creates a definition of static information based upon the goods or services available for purchase and selectively updates the static information into the database from the subsystem.

Preferably, static information is up-dated regularly.

Preferably, static information is up-loaded into the user interface from the database via the middleware when the user interface is started.

Preferably, the definition of static information may be changed to include or exclude certain information depending upon subsystem requirements.

Preferably, the middleware uploads information from the sub-systems to the database.

Preferably, the middleware has a separate interaction with each sub-system.

Preferably, the middleware creates a definition of dynamic information based upon the goods and/or services available for purchase.

Preferably, the definition of dynamic information may be changed to include or exclude certain information depending upon subsystem requirements.

Preferably, dynamic information may be queried in real time.

The user interface can query the dynamic information via the middleware.

### BRIEF DESCRIPTION OF THE DRAWINGS

The present invention will now be described by way of example only with reference to the accompanying drawings in which:

FIG. 1 is a schematic diagram of a system in accordance with the present invention;

FIG. 2 is a flow diagram showing procedural steps for the initial set-up of a user interface, in this case a set-top box;

FIG. 3 is a flow diagram showing additional detailed features of the procedural steps for populating a graphical user interface and for amending and updating the interface;

FIG. 4 is a flow diagram showing the process by which goods and services are added to a shopping cart and then purchased in accordance with the present invention;

FIG. 5 is a flow diagram showing the notification of a hotel guest, in accordance with the present invention;

FIG. 6 is a flow diagram showing user interaction with a system in accordance with the present invention;

FIG. 7 is a flow diagram which shows the interaction of a scheduler and an EPOS system in accordance with the present invention; and

FIG. 8 is a flow diagram which shows the process of fulfilling an order in accordance with the present invention.

### DETAILED DESCRIPTION OF THE DRAWINGS

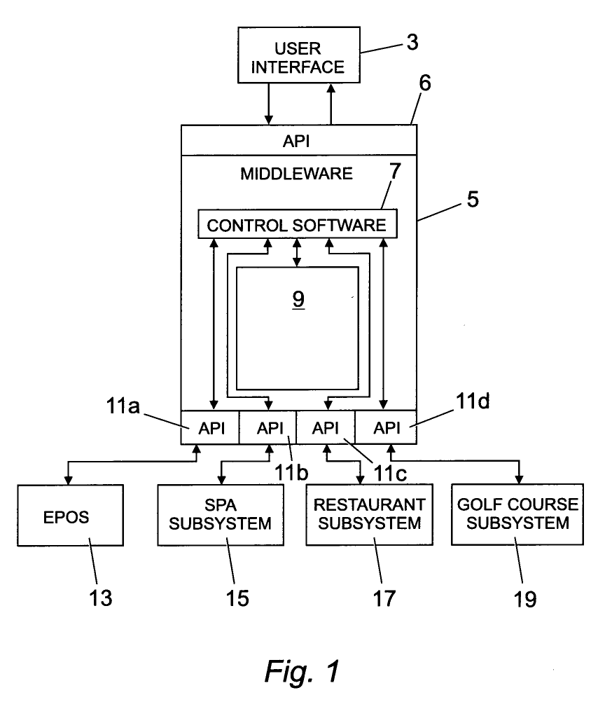

FIG. 1 shows a system 1 in accordance with the present invention. The system comprises a user interface 3, middleware 5 which, in turn, comprises control software 7, a database 9 and application programming interfaces (API) 6 and 11a-11d. The middleware 5 is connected to an electronic point of sale device or system (EPOS) 13 as well as three sub-systems which, in this example, are dedicated booking systems which allow hotel guests to book the spa 15, the restaurant 17 and the golf course 19.

One purpose of the present invention is to allow a hotel guest to access a range of goods and services available in the hotel through a single user interface, typically the graphical user interface (GUI) provided on a television or other visual display unit (VDU) that is available to the hotel guest in their room.

In another example of the present invention, the GUI may be provided to the user via a laptop computer connected to the middleware server 5 of the hotel. This connection may be wireless or provided via a standard wire connection in the room. Wireless connectivity will allow the user to access various goods and services anywhere in the hotel where the wireless network is in operation. In addition, the system may be provided via a URL to which a hotel guest may be granted access prior to arrival at the hotel but once his hotel booking has been confirmed.

The present invention further provides a converged network that is, one where all services are contained on a single shared network.

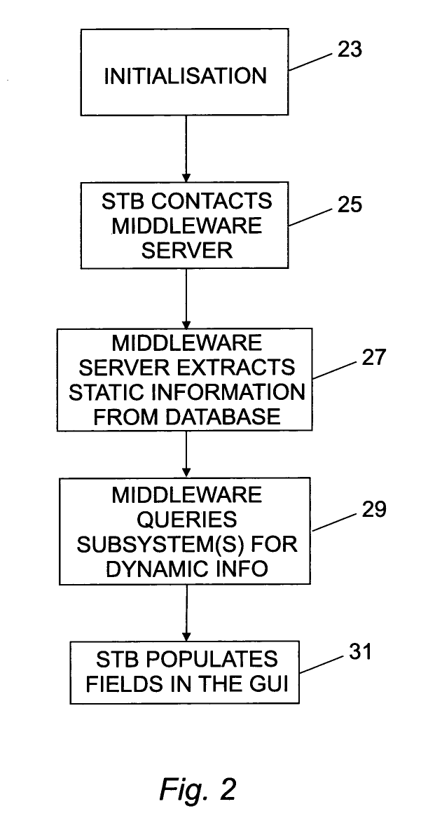

The embodiment of the present invention shown in FIG. 1 will now be described with reference to FIGS. 2-5. These figures are flow diagrams which show various aspects of the method or process of operation of the present invention. It will be appreciated that other embodiments of the invention which fall within the overall scope and spirit of the invention but which differ in various detailed aspects are conceivable.

FIG. 2 describes the process or method by which the user interface module is initialised. This process may commence once a user or guest has checked into a hotel and may be started from the reception or other area by a member of hotel staff or may be started by the guest when they enter the room at the beginning of their stay. Initialisation may also occur when the system is installed in a room and need not be dependent upon the room being occupied or reserved.

The following description relates to the information received by the set-top box which is displayable on a GUI. Initialisation commences 23 and the set-top box contacts the middleware software 25. At this point the set-top box receives sub-system information from sub-systems via the middleware such as those shown in FIG. 1 (reference numerals 15, 17 and 19).

The information provided to the middleware can be either static information or dynamic information. The static information is extracted from the database by the middleware and provided to the GUI 31. The static information may also be that which is determined or defined by the hotel to be information that is not likely to change frequently. For example, static information may comprise the actual tee off times on the hotel golf course, a range of food available on a menu at a specific restaurant or a range of treatments available in a spa.

Dynamic information 29 is that which can or is likely to change over the duration of a stay. This may include the availability of tee off times on a golf course or spa treatments or certain goods or services available for sale. Once the set-top box has obtained the dynamic information on the services available from the sub-systems via the middleware 29, the set-top box populates the fields in the graphical user interface 31.

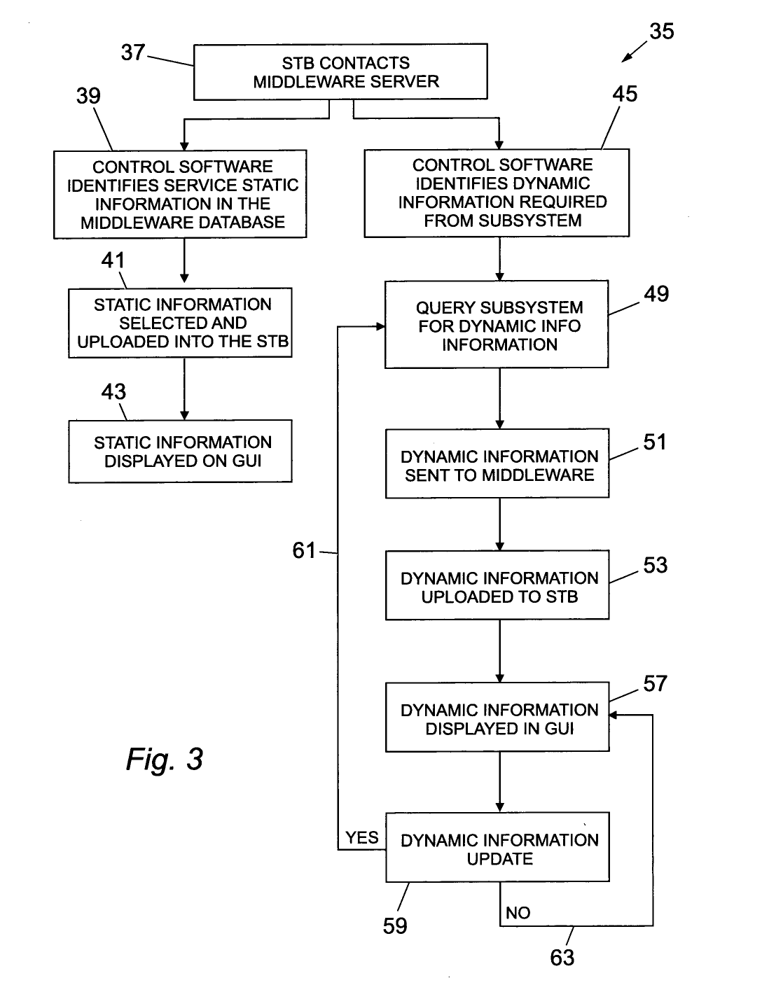

FIG. 3 is a flow diagram showing the process 35 by which the graphical user interface is populated and updated. This figure provides additional information to that shown in FIG. 2. In this diagram, the set-top box contacts the middleware server 37 which, using the control software 7, determines which static and dynamic information is required to populate the graphical user interface in connection with services provided by a specific sub-system such as those shown in FIG. 1 at reference numeral 15, 17 and 19.

In the case of static information, the control software 39 identifies service static information in the middleware database 39. Thereafter, the static information is selected and uploaded into the set-top box 41 and the static information is displayed on the graphical user interface 43.

In connection with the dynamic information, the control software identifies dynamic information required from the sub-system 45. At this stage the sub-system is queried for dynamic information 49, the dynamic information is sent to the middleware 51, dynamic information is then up-loaded to the set-top box 53 and then the dynamic information is displayed on the graphical user interface 57.

Thereafter a query 59 is run in order to determine whether the dynamic information requires to be updated. If the answer is yes 61, steps 49 to 57 are repeated. If no, then the existing dynamic information continues to be displayed on the graphical user interface.

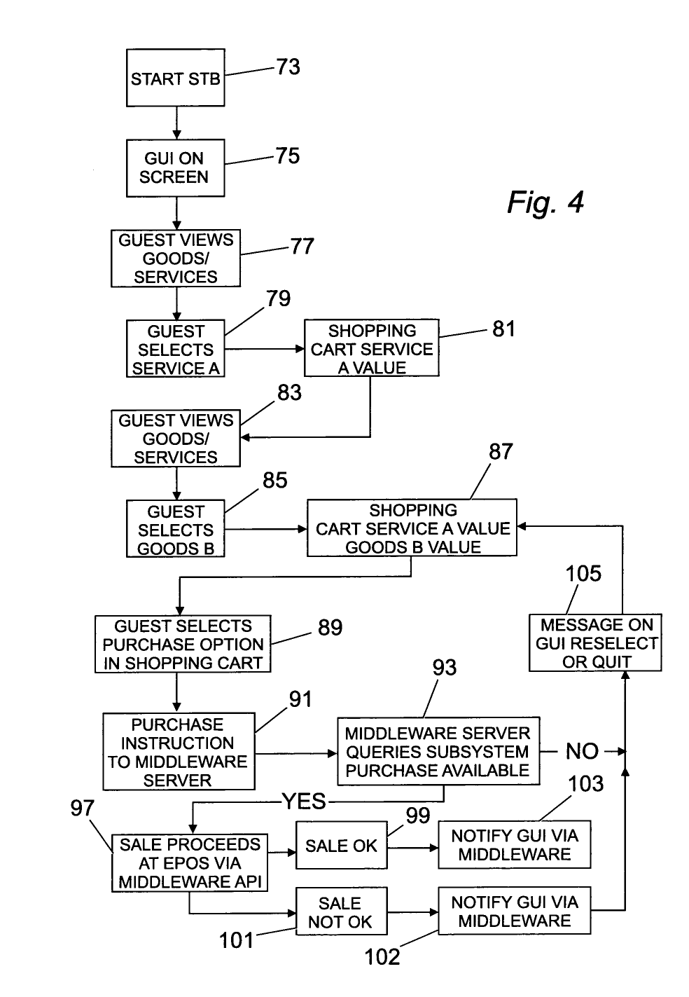

FIG. 4 shows the process by which a guest may buy goods or services using a system and method in accordance with the present invention. The process 71 begins with the user starting the set-top box 73. The graphical user interface is displayed on the screen 75 and the guests then views good or services available for purchases 77. At this stage, the guest may select a service A 79 at which point the service and other information such as the value of the service is added to a shopping cart. This information may further include dynamic information such as the time for which the service has been booked and e.g. detailed selection criteria for how a guest might want the food he has ordered to be cooked.

Once this service A has been added to the shopping cart 81, the guest may view the goods and services again 83 and the guest may select, for example a set of goods B 85. These goods can be added to the same shopping cart 87 as service A and information such as the value of these goods included in the shopping cart. This process may continue until the guest has booked a range of goods and services.

It is envisaged that this type of use of the present invention may occur at the beginning of a holiday, for example, when the guest is planning the activities they wish to undertake during their stay. Once the process of booking goods and services has been completed the guest selects the purchase option in the shopping cart 89, a purchase instruction is sent to the middleware server 91 and the middleware server queries the sub-systems to determine whether the purchase is available 93. This represents a final check of the sub-systems that is made in order to ensure that the user can validly purchase the goods or services in question.

If the goods and/or services are unavailable as specified by the user a message 105 is sent to and displayed on the GUI informing the user of this and the user is asked to reselect or cancel the order. Where the purchase as specified by the user is available, the sale proceeds at the EPOS via the middleware API 97. Once the transaction has been completed 99, a message is sent to and displayed on the GUI informing the user that the transaction has been completed. If for any reason, the sale cannot be completed at the EPOS 97, the GUI is notified via the middleware 103 and message 105 is sent to and displayed on the GUI informing the user of this and the user is asked to reselect or cancel the order.

It is expected that where a significant amount of dynamic information is used in the system then the extent to which the user will find that the goods or services are unavailable at this stage will be minimised. If the goods or services are unavailable, then the guest is returned to the shopping cart where he may amend his choice or simply delete the goods or services that are currently unavailable. If the goods or services are available then an instruction is sent from the sub-system to the middleware server and the system forwards that information on to the EPOS system.

The present invention provides a converged network where the middleware server is provided with control software and an API that allows substantially seamless communication between a range of sub-systems and one or more EPOS system. This allows the user not only to select various services but also to purchase them in a single action available to them via an easily understandable graphical user interface.

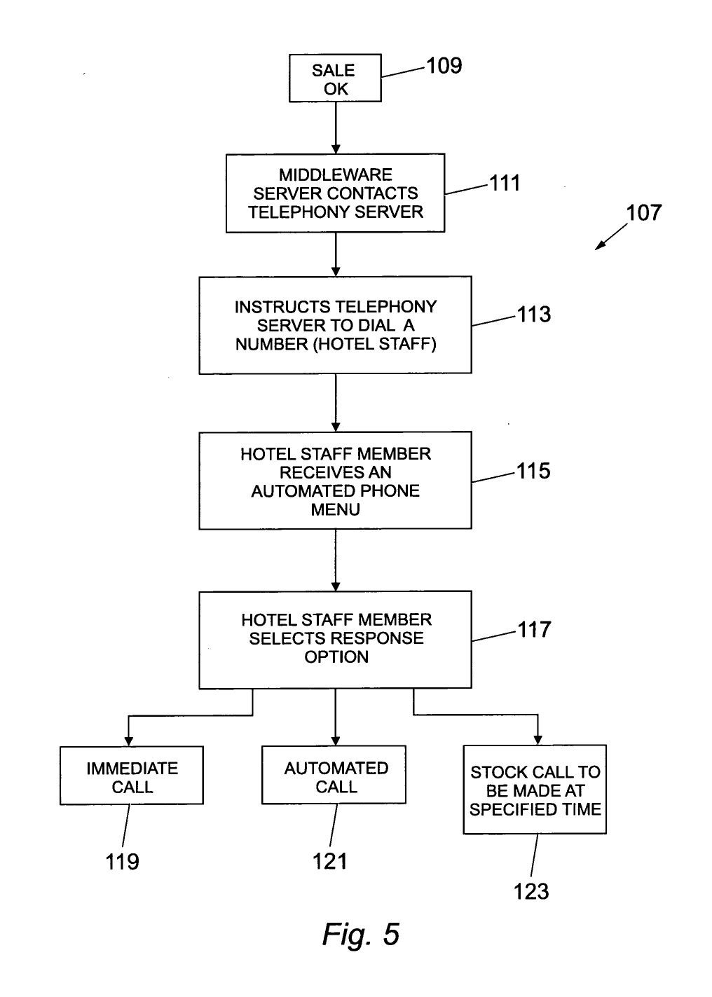

FIG. 5 is a flow diagram showing the notification of a hotel guest, in accordance with the present invention.

The flow diagram 109 describes one way in which the user may receive a reminder concerning the goods or serviced he has purchased.

After confirmation of the sale 109, the middleware server contacts the hotel's telephony server 111. The telephony server is instructed to dial a telephone number. In this example the telephone number is that of a member of staff who is provided with an automated menu of choices 115 from the phone server.

The hotel staff member selects the appropriate response which might be to call back the guest's room immediately 119 in order to talk to the guest, create an automatic call 121 for immediate transfer to the guest's room or to have a call to the guest room programmed 123 to occur at a set time. A number of these calls can be made stored and made automatically at the appropriate time. In addition, where for example, a guest has booked a game of golf, a reminder may be sent to guest rooms other than the room of the guest who made the booking.

Reminders may also be sent to a guest's mobile phone or to an e-mail account where the hotel's property management system has been provided with that information.

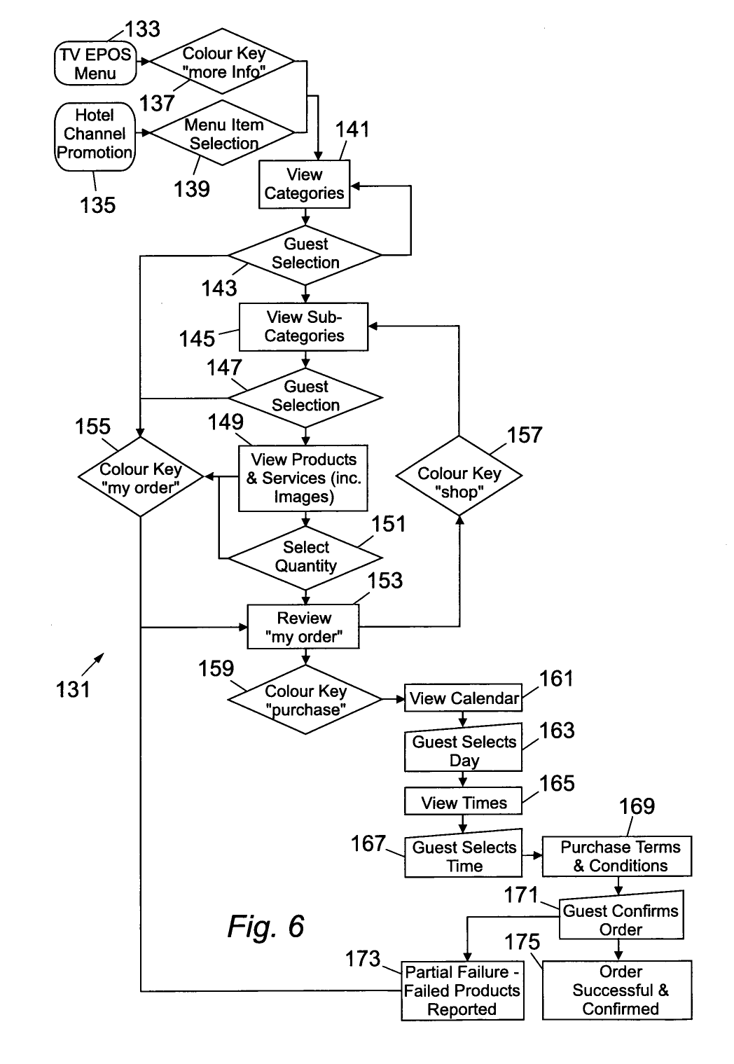

FIG. 6 is a flow diagram showing user interaction with the system in accordance with the present invention. The user is presented with a TV EPOS Menu 133 and/or Hotel Channel Promotion interface 135. Where the TV EPOS Menu 133 is used, ‘more info’ 137 is selected using a colour key. This allows the user to view categories of various goods and services that are available 141. Where the Hotel Channel Promotion interface 135 is used, item selection is available from a menu which then allows categories to be viewed 141.

Thereafter, the user makes a selection 143 which either allows them to view sub-categories 145 or to select a coloured key which allows them to view the order 155. If the sub-categories 145 are viewed the user may make a selection 147 to view products and services 149. The quantity 151 can be selected and the order directly reviewed via the “my order” colour key 155. At this point, the user may return to the view sub-categories item 145 via the shop colour key 157. Thereafter the purchase colour key 159 may be used to allow the user to view the calendar 161, then select a day 163, view times 165, select a time 167. Thereafter purchase terms and conditions are made available to the user who confirms the order 171.

Where a partial failure of the system occurs, this failure is reported to the user by the review order item 153. Where the order is successful, this information is also communicated to the user 175.

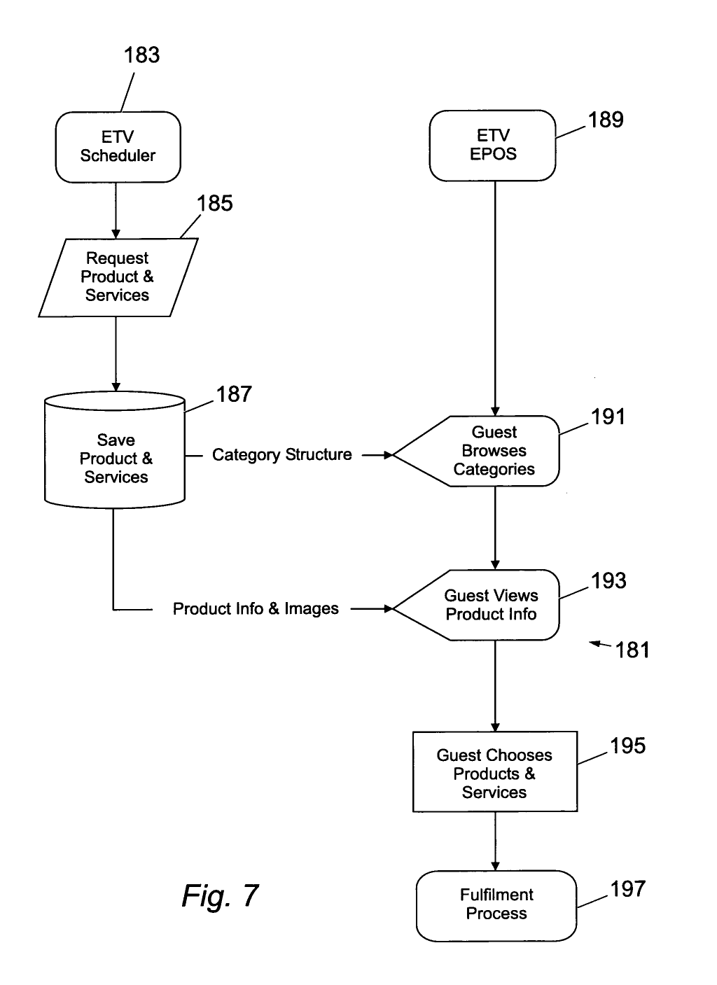

FIG. 7 is a flow diagram 181 which shows the interaction of a Scheduler and an EPOS system in accordance with the present invention. The ETV Scheduler 183 has functionality which allows the user to request products and services. These are provided via a database 187, which provides category and structure information and also product information and images. The EPOS system 198 provides functionality to allow users to browse categories 191 to allow users to view product information from which a user will choose a product or service and proceed to the order fulfilment process 197.

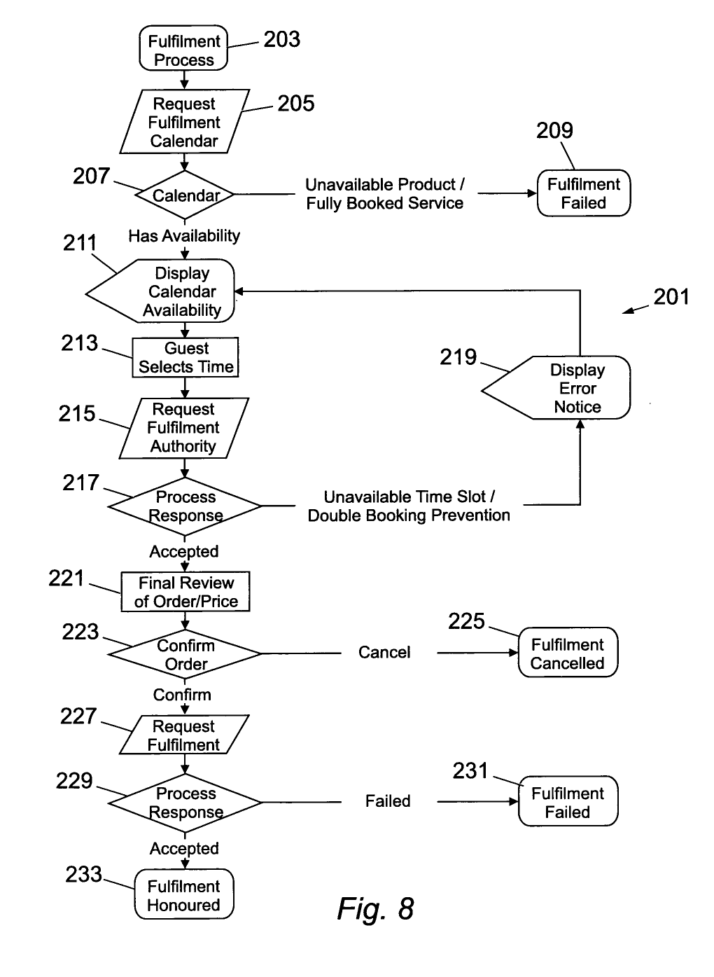

FIG. 8 is a flow diagram which shows the process of fulfilling an order in accordance with the present invention. Process 201 begins when the instruction to proceed to the fulfilment process 203 is received. Thereafter the fulfilment calendar is requested 205, once the calendar is received the user will select a slot in the calendar and either the fulfilment will have failed 209 because of the unavailability of the product or service or the fulfilment may proceed to the next stage because there is availability 211. Thereafter the user selects time 213, requests fulfilment authority 215 and there is a process response which can either accept or decline the selection made thus far. Where the selection is declined because, for example, of the unavailability of a time slot or to prevent double booking, an error notice 219 is displayed and the user is taken back to the display calendar availability stage 211. Where it is accepted, a final review of the order or price 221 is undertaken and the user may choose to confirm or cancel the order as shown by fulfilment cancel 225 or request fulfilment 227. Thereafter the process response is either to accept, in which case the fulfilment is honoured 233, or to fail, where the fulfilment is failed 231.

Improvements and modifications may be incorporated herein without deviating from the scope of the invention.

What is claimed is:

1. A system for displaying, selecting and purchasing goods and/or services in a hotel or lodging, the system comprising:
a user interface adapted to display a range of goods and/or services available for purchase;
at least one sub-system which acts as a source of information on the goods and/or services available for purchase;
a server comprising middleware, the server being in communication with the at least one sub-system to receive the information on the goods and/or services available for purchase and to provide said information to the user interface;
means for gathering and processing information on goods and/or services selected for purchase; and
an electronic point of sale (EPOS) system adapted to receive the information on the good and/or services selected for purchase from the middleware and to process the sale.

2. The system of claim 1, wherein the EPOS system manages fulfillment of the order for the goods and/or services.

3. The system of claim 1, wherein the user interface comprises a graphical user interface (GUI) controlled by an input/output device.

4. The system of claim 3, wherein, the GUI comprises a series of templates displayable on a screen, the templates being populated with information from the middleware.

5. The system of claim 3, wherein the input/output device comprises a set-top box.

6. The system of claim 3, wherein the input/output device comprises a personal computer, PDA, mobile device or information and sales kiosk.

7. The system of claim 6, wherein the kiosk comprises user identification means.

8. The system of claim 7, wherein the user identification means comprises a machine readable device.

9. The system of claim 8, wherein the machine readable device comprises an RFID device.

10. The system of claim 1, wherein the sub-system comprises a facility or service booking system which can be configured to allow the user to book the services of a spa in the hotel or sports facilities or a time for playing golf, room services or any other similar hotel service.

11. The system of claim 1, wherein the middleware comprises a database, an application programming interface (API) and a control module.

12. The system of claim 1, wherein the middleware creates a definition of static information based upon the goods and/or services available for purchase and selectively updates the static information into the database from the subsystem.

13. The system of claim 12, wherein the static information is updated regularly.

14. The system of claim 12, wherein the static information is uploaded into the user interface from the database via the middleware when the user interface is started.

15. The system of claim 12, wherein the definition of static information may be changed to include or exclude certain information depending upon subsystem requirements.

16. The system of claim 1, wherein the middleware uploads information from the sub-systems to the database.

17. The system of claim 1, wherein the middleware has a separate interaction with each sub-system.

18. The system of claim 1, wherein EPOS subsystems are provided by a single server.

19. The system of claim 1, wherein the middleware creates a definition of dynamic information based upon the goods and/or services available for purchase.

20. The system of claim 19, wherein the definition of dynamic information may be changed to include or exclude certain information depending upon subsystem requirements.

21. The system of claim 19, wherein dynamic information may be queried in real time.

22. The system of claim 19, wherein the middleware is adapted to provide dynamic queries of the sub-systems to ascertain the availability or validity of a choice made by a user.

23. A method for displaying, selecting and purchasing goods or services in a hotel or lodging, the method comprising the steps of:
providing information on the goods and/or services available for purchase from at least one sub-system to middleware in communication with the, at least, one sub-system;
displaying the range of goods and/or services available for purchase on a user interface;
gathering and processing information on goods and/or services selected for purchase; and
sending the information on the good and/or services selected for purchase to an electronic point of sale (EPOS) system and processing the sale.

24. The method of claim 23, wherein the EPOS system manages fulfillment of the order for the goods and/or services.

25. The method of claim 23, wherein the user interface comprises a graphical user interface (GUI) controlled by an input/output device.

26. The method of claim 25, wherein the GUI comprises a series of templates displayable on a screen, the templates being populated with information from the middleware.

27. The method of claim 23, wherein the sub-system comprises a facility or service booking system which can be configured to allow the user to book the services of a spa in the hotel or sports facilities or a time for playing golf, room services or any other similar hotel service.

28. The method of claim 23, wherein the middleware comprises a database, an application programming interface (API) and a control module.

29. The method of claim 23, wherein the middleware creates a definition of static information based upon the goods or services available for purchase and selectively updates the static information into the database from the subsystem.

30. The method of claim 29, wherein the static information is up-dated regularly.

31. The method of claim 29, wherein the static information is up-loaded into the user interface from the database via the middleware when the user interface is started.

32. The method of claim 29, wherein the definition of static information may be changed to include or exclude certain information depending upon subsystem requirements.

33. The method of claim 23, wherein the middleware uploads information from the sub-systems to the database.

34. The method of claim 23, wherein the middleware has a separate interaction with each sub-system.

35. The method of claim 23, wherein the middleware creates a definition of dynamic information based upon the goods and/or services available for purchase.

36. The method of claim 35, wherein the definition of dynamic information may be changed to include or exclude certain information depending upon subsystem requirements.

37. The method of claim 35, wherein dynamic information may be queried in real time.

38. The method of claim 35, wherein user interface can query the dynamic information via the middleware.
